(19) United States
(12) Patent Application Publication
(10) Pub. No.: US 2022/0314989 A1
(43) Pub. Date: Oct. 6, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Nobuharu Nagaoka, Wako-shi (JP); Yuki Sugano, Wako-shi (JP); Ryota Okutsu, Wako-shi (JP)

(21) Appl. No.: 17/669,406

(22) Filed: Feb. 11, 2022

(30) Foreign Application Priority Data
Mar. 31, 2021 (JP) 2021-059061

(51) Int. Cl. B60W 30/16; B60W 30/14; B60W 40/06; B60W 40/105; B60W 60/00; G06V 20/56

(52) U.S. Cl. CPC B60W 30/16; B60W 30/143; B60W 40/06; B60W 40/105; B60W 60/0015; G06V 20/588; B60W 2552/53; B60W 2554/80; B60W 2555/20

(57) ABSTRACT

There is provided a vehicle control device including: a recognizer that recognizes a situation of the vicinity of a subject vehicle and an action plan generator that generates an action plan of the subject vehicle based on a result of the recognition of the vicinity of the subject vehicle acquired by the recognizer, in which the recognizer recognizes an inter-vehicle distance between the subject vehicle and another vehicle traveling in front of the subject vehicle, and the action plan generator generates an action plan for changing the inter-vehicle distance between the subject vehicle and the other vehicle based on the result of the recognition of the inter-vehicle distance.

### CROSS-REFERENCE TO RELATED APPLICATION

Priority is claimed on Japanese Patent Application No. 2021-059061, filed Mar. 31, 2021, the content of which is incorporated herein by reference.

### BACKGROUND

### Field of the Invention

The present invention relates to a vehicle control device, a vehicle control method, and a storage medium.

### Description of Related Art

In the related art, technologies for recognizing road partition lines and preceding vehicles and controlling movement of a vehicle in a horizontal direction using positions thereof as references in traveling control of the vehicle have been developed (PCT International Publication No. 2019/167231).

### SUMMARY

However, in the related art, in a situation in which a subject vehicle is traveling on a road surface that is in a wet state at the time of raining or the like, there are cases in which it becomes difficult to recognize road partition lines, or a recognition accuracy of preceding vehicles is degraded in accordance with an influence of water being raised up by preceding vehicles, and the stability of horizontal control is degraded.

The present invention is in view of such situations, and one object thereof is to provide a vehicle control device, a vehicle control method, and a storage medium capable of more stably controlling movement of a subject vehicle in a horizontal direction in a situation in which the subject vehicle is traveling on a road surface that is in a wet state.

A vehicle control device, a vehicle control method, and a storage medium according to the present invention employ the following configurations.

(1): According to one aspect of the present invention, there is provided a vehicle control device including: a storage device configured to store a program; and a hardware processor, in which, by executing the program stored in the storage device, the hardware processor performs: a recognition process of recognizing a situation of the vicinity of a subject vehicle; and an action plan generating process of generating an action plan of the subject vehicle based on a result of the recognition of the vicinity of the subject vehicle, an inter-vehicle distance between the subject vehicle and another vehicle traveling in front of the subject vehicle is recognized in the recognition process, and the action plan for changing the inter-vehicle distance between the subject vehicle and the other vehicle is generated based on the result of the recognition of the inter-vehicle distance in the action plan generating process.

(2): In the aspect (1) described above, the hardware processor generates a first action plan for increasing the inter-vehicle distance between the subject vehicle and the other vehicle in a case in which an accuracy of recognition of road partition lines using a recognizer is degraded beyond a specific allowed range.

(3): In the aspect (2) described above, the case in which the accuracy of recognition of the road partition lines is degraded beyond the specific allowed range is a case in which a magnitude of fluctuation of the result of the recognition of the inter-vehicle distance is equal to or larger than a first threshold.

(4): In the aspect (3) described above, the hardware processor generates a second action plan for decreasing the inter-vehicle distance between the subject vehicle and the other vehicle in a case in which the magnitude of fluctuation of the result of the recognition of the inter-vehicle distance is equal to or smaller than a second threshold that is smaller than the first threshold.

(5): In any one of the aspects (2) to (4) described above, the hardware processor determines the inter-vehicle distance after change in accordance with a current traveling speed of the subject vehicle.

(6): In any one of the aspects (2) to (5) described above, in a case in which the accuracy of recognition of the road partition lines is not enhanced to be within the allowed range even when traveling control of the subject vehicle is performed using the first action plan, the hardware processor recognizes a traveling trajectory of the other vehicle as a substitute marker for the road partition lines from an image of a road on which the other vehicle has traveled.

(7): According to one aspect of the present invention, there is provided a vehicle control method using a computer, the vehicle control method including: a recognition process of recognizing a situation of the vicinity of a subject vehicle; and an action plan generating process of generating an action plan of the subject vehicle based on a result of the recognition of the vicinity of the subject vehicle in the recognition process, in which an inter-vehicle distance between the subject vehicle and another vehicle traveling in front of the subject vehicle is recognized in the recognition process, and the action plan for changing the inter-vehicle distance between the subject vehicle and the other vehicle is generated based on the result of the recognition of the inter-vehicle distance in the action plan generating process.

(8): According to one aspect of the present invention, there is provided a computer-readable non-transitory storage medium storing a program thereon, the program causing a computer to perform: a recognition process of recognizing a situation of the vicinity of a subject vehicle; and an action plan generating process of generating an action plan of the subject vehicle based on a result of the recognition of the vicinity of the subject vehicle in the recognition process, in which an inter-vehicle distance between the subject vehicle and another vehicle traveling in front of the subject vehicle is recognized in the recognition process, and the action plan for changing the inter-vehicle distance between the subject vehicle and the other vehicle is generated based on the result of the recognition of the inter-vehicle distance in the action plan generating process.

According to the aspects (1) to (8) described above, an inter-vehicle distance between the subject vehicle and another vehicle traveling in front of the subject vehicle is recognized, and the inter-vehicle distance between the subject vehicle and the other vehicle is changed based on the result of the recognition of the inter-vehicle distance, whereby, in a situation in which the subject vehicle is traveling on a road surface that is in a wet state, movement of the subject vehicle in the horizontal direction can be controlled more stably.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram illustrating an example of a correspondence relation among a drive mode, a control state of a subject vehicle, and a task.

FIG. 4 is a diagram illustrating an overview of a wet-time action planning function that is included in an action plan generator.

FIG. 5 is a flowchart illustrating an example of the flow of a wet-time action plan generating process that is performed by the action plan generator.

FIG. 6 is a diagram illustrating an overview of a substitute marker recognizing function of a recognizer.

FIG. 7 is a flowchart illustrating an example of the flow of a process of the action plan generator generating an action plan based on a recognition result of a substitute marker.

### DESCRIPTION OF EMBODIMENTS

Hereinafter, a vehicle control device, a vehicle control method, and a storage medium according to embodiments of the present invention will be described with reference to the drawings. As used throughout this disclosure, the singular forms “a,” “an,” and “the” include plural reference unless the context clearly dictates otherwise.

### [Entire Configuration]

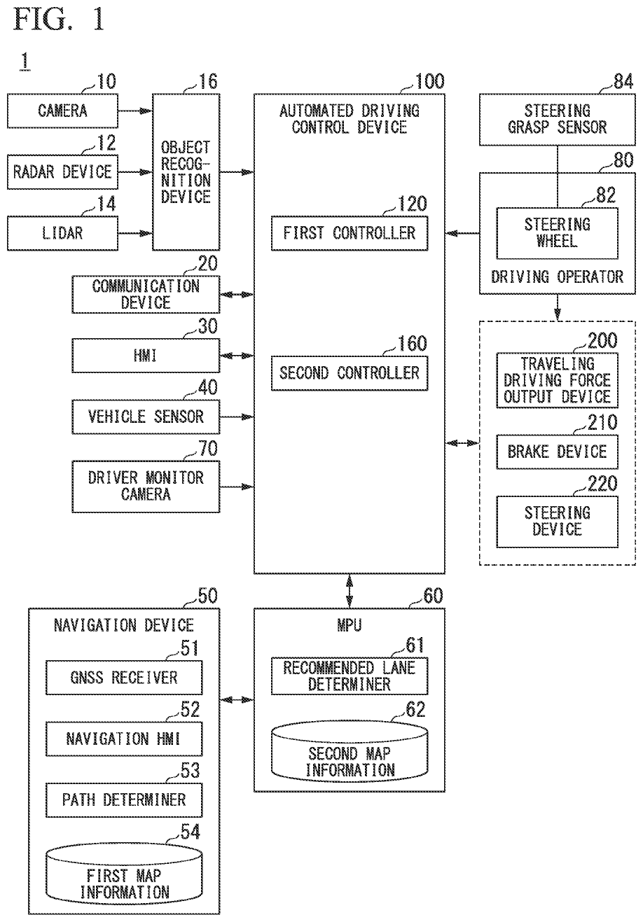

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or discharge power of a secondary cell or a fuel cell.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, an automated driving control device 100, a traveling driving force output device 200, a brake device 210, and a steering device 220. Such devices and units are mutually connected using a multiplexing communication line such as a controller area network (CAN) communication line, a serial communication line, a radio communication network, or the like. The configuration illustrated in FIG. 1 is merely an example, and a part of the configuration may be omitted, and an additional configuration may be further added.

The camera 10, for example, is a digital camera using a solid-state imaging device such as a charge coupled device (CCD) or a complementary metal oxide semiconductor (CMOS). The camera 10 is installed at an arbitrary place in a vehicle (hereinafter, a subject vehicle M) in which the vehicle system 1 is mounted. In a case in which a side in front is to be imaged, the camera 10 is attached to an upper part of a front windshield, a rear face of a room mirror, or the like. The camera 10, for example, periodically images the vicinity of the subject vehicle M repeatedly. The camera 10 may be a stereo camera.

The radar device 12 emits radio waves such as millimeter waves to the vicinity of the subject vehicle M and detects at least a position of (a distance and an azimuth) a target object by detecting radio waves (reflected waves) reflected by the target object. The radar device 12 is installed at an arbitrary place on the subject vehicle M. The radar device 12 may detect a position and a speed of an object using a frequency modulated continuous wave (FM-CW) system.

The LIDAR 14 emits light (or a radiowave having a wavelength close to light) to the vicinity of the subject vehicle M and measures scattered light. The LIDAR 14 detects a distance to a target based on a time from light emission to light reception. For example, the emitted light is pulse-shaped laser light. The LIDAR 14 is attached to an arbitrary place in the subject vehicle M.

The object recognition device 16 performs a sensor function process for detection results acquired using some or all of the camera 10, the radar device 12, and the LIDARs 14, thereby recognizing a position, a type, a speed, and the like of an object. The object recognition device 16 outputs results of the recognition to the automated driving control device 100. The object recognition device 16 may directly output detection results acquired by the camera 10, the radar device 12, and the LIDAR 14 to the automated driving control device 100. The object recognition device 16 may be omitted from the vehicle system 1.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to an occupant of the subject vehicle M and receives an input operation performed by a vehicle occupant. The HMI 30 includes various display devices, a speaker, a buzzer, a touch panel, switches, keys, and the like.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 50, for example, includes a global navigation satellite system (GNSS) receiver 51, a navigation HMI 52, and a path determiner 53. The navigation device 50 stores first map information 54 in a storage device such as a hard disk drive (HDD) or a flash memory. The GNSS receiver 51 identifies a position of the subject vehicle M based on signals received from GNSS satellites. The position of the subject vehicle M may be identified or complemented using an inertial navigation system (INS) that uses the output of the vehicle sensor 40. The navigation HMI 52 includes a display device, a speaker, a touch panel, a key, and the like. The navigation HMI 52 may be configured to be partially or entirely common as the HMI 30 described above. The path determiner 53, for example, determines a path from a position of the subject vehicle M identified by the GNSS receiver 51 (or an input arbitrary position) to a destination input by a vehicle occupant using the navigation HMI 52 (hereinafter referred to as a path on a map) by referring to the first map information 54. The first map information 54, for example, is information in which a road form is represented using respective links representing roads and respective nodes connected using the links. The first map information 54 may include a curvature of each road, point of interest (POI) information, and the like. The path on the map is output to the MPU 60. The navigation device 50 may perform path guide using the navigation HMI 52 based on the path on the map. The navigation device 50, for example, may be realized using a function of a terminal device such as a smartphone, a tablet terminal, or the like held by the vehicle occupant. The navigation device 50 may transmit a current position and a destination to a navigation server through the communication device 20 and acquire a path equivalent to the path on the map from the navigation device.

The MPU 60, for example, includes a recommended lane determiner 61 and stores second map information 62 in a storage device such as an HDD or a flash memory. The recommended lane determiner 61 divides the path on the map provided from the navigation device 50 into a plurality of blocks (for example, divides the path into blocks of 100 [m] in the advancement direction of the vehicle) and determines a recommended lane for each block by referring to the second map information 62. The recommended lane determiner 61 determines in which of lanes numbered from the left side to travel. In a case in which there is a branching place in the path on the map, the recommended lane determiner 61 determines a recommended lane such that the subject vehicle M can travel along a reasonable path for advancement to a branching destination.

The second map information 62 is map information having higher accuracy than the first map information 54. The second map information 62, for example, includes information on the centers of respective lanes, information on boundaries between lanes and the like. In addition, in the second map information 62, road information, traffic regulation information, address information (addresses and postal codes), facility information, telephone number information, information of prohibition sections in which a mode A or a mode B to be described below is prohibited, and the like may be included. The second map information 62 may be updated as needed by the communication device 20 communicating with another device.

The driver monitor camera 70, for example, is a digital camera using solid-state imaging elements such as a CCD or a CMOS. The driver monitor camera 70 is attached at an arbitrary place in the subject vehicle M in such a position and a direction that a head part of a vehicle occupant sitting on a driver seat of the subject vehicle M (hereinafter referred to as a driver) can be imaged in front (in a direction in which a face is imaged). For example, the driver monitor camera 70 is attached above a display device disposed at the center of an instrument panel of the subject vehicle M.

The driving operator 80, for example, includes an acceleration pedal, a brake pedal, a shift lever, and other operators in addition to the steering wheel 82. A sensor detecting the amount of an operation or the presence/absence of an operation is installed in the driving operator 80, and a result of detection thereof is output to the automated driving control device 100 or some of all of the traveling driving force output device 200, the brake device 210, and the steering device 220. The steering wheel 82 is one example of “an operator that accepts a driver's steering operation”. The operator does not necessarily need to be in a circular form and may be in the form of a variant steering wheel, a joystick, a button, or the like. A steering grasp sensor 84 is attached to the steering wheel 82. The steering grasp sensor 84 is realized by a capacitive sensor or the like and outputs a signal that can be used for detecting whether or not a driver is grasping the steering wheel 82 (this represents that the driver is contacting the steering wheel in the state of adding a force thereto) to the automated driving control device 100.

The automated driving control device 100, for example, includes a first controller 120 and a second controller 160. Each of the first controller 120 and the second controller 160, for example, is realized by a hardware processor such as a central processing unit (CPU) executing a program (software). Some or all of such constituent elements may be realized by hardware (a circuit; includes circuitry) such as a large scale integration (LSI), an application specific integrated circuit (ASIC), a field-programmable gate array (FPGA), a graphics processing unit (GPU), or the like or may be realized by software and hardware in cooperation. The program may be stored in a storage device (a storage device including a non-transitory storage medium) such as an HDD, a flash memory, or the like of the automated driving control device 100 in advance or may be stored in a storage medium such as a DVD or a CD-ROM that can be loaded or unloaded and installed in the HDD or the flash memory of the automated driving control device 100 by loading the storage medium (a non-transitory storage medium) into a drive device. The automated driving control device 100 is one example of a “vehicle control device”.

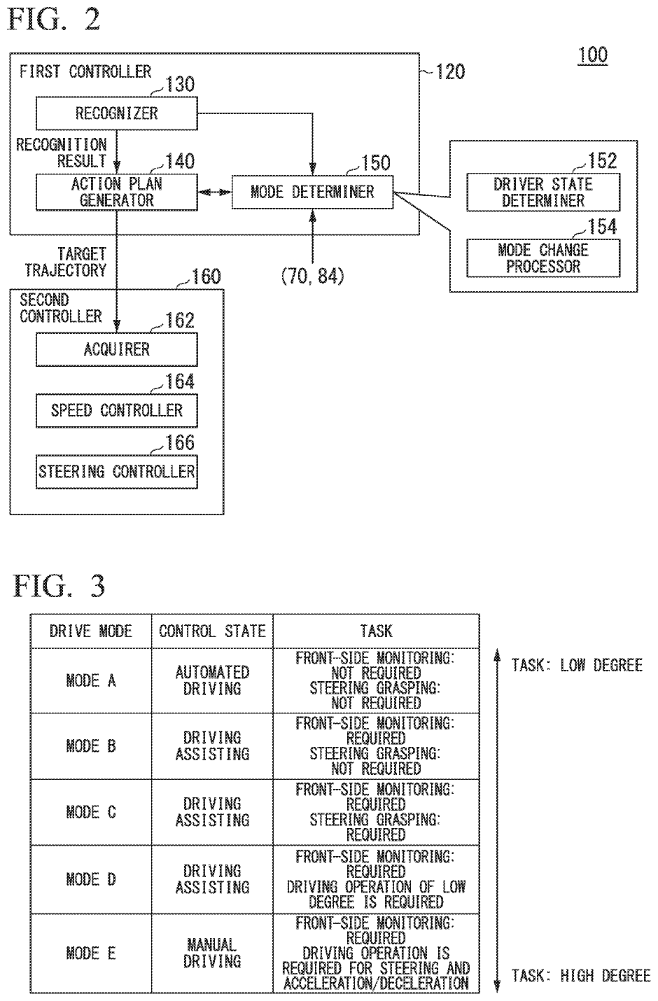

FIG. 2 is a functional configuration diagram of the first controller 120 and the second controller 160. The first controller 120, for example, includes a recognizer 130, an action plan generator 140, and a mode determiner 150. The first controller 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (there are a signal, a road marking, and the like that can be used for pattern matching) at the same time and comprehensively evaluating both recognitions by assigning scores to them. Accordingly, the reliability of automated driving is secured.

The recognizer 130 recognizes states such as positions, speeds, and accelerations of objects present in the vicinity of the subject vehicle M based on information input from the camera 10, the radar device 12, and the LIDAR 14 through the object recognition device 16. A position of an object, for example, is recognized as a position on absolute coordinates using a representative point (a center, a drive axis center, or the like) of the subject vehicle M as its origin and is used for control. The position of the object may be represented as a representative point such as a center, a corner, or the like of the object or may be represented in an expressed area. A “state” of an object may include an acceleration and a jerk or a “behavior state” of the object (for example, whether or not the object is changing lanes or is about to change lanes).

For example, the recognizer 130 recognizes a lane in which the subject vehicle is traveling (traveling lane). For example, the recognizer 130 recognizes a traveling lane by comparing a pattern (for example, an arrangement of solid lines and broken lines) of road partition lines acquired from the second map information 62 with a pattern of road partition lines in the vicinity of the subject vehicle M recognized from an image captured by the camera 10. The recognizer 130 may recognize a traveling lane by recognizing not only road partition lines but traveling road boundaries (road boundaries) including road partition lines, road shoulders, curbstones, a median strip, guard rails, and the like. In this recognition, the location of the subject vehicle M acquired from the navigation device 50 or a processing result acquired by the INS may be taken into account as well. The recognizer 130 recognizes a temporary stop line, an obstacle, a red signal, a toll gate, and other road events.

When recognizing a traveling lane, the recognizer 130 recognizes a position and a posture of the subject vehicle M with respect to the traveling lane. The recognizer 130, for example, may recognize a deviation of a reference point of the subject vehicle M from the center of the lane and an angle formed with respect to a line in which the center of the lane in the advancement direction of the subject vehicle M is aligned as a relative position and a posture of the subject vehicle M with respect to the traveling lane. Instead of this, the recognizer 130 may recognize the position of the reference point of the subject vehicle M with respect to one side end part (a road partition line or a road boundary) of the traveling lane or the like as a relative position of the subject vehicle M with respect to the traveling lane.

The action plan generator 140 basically travels in a recommended lane determined by the recommended lane determiner 61 and generates a target trajectory along which the subject vehicle M will automatedly travel (travel without being dependent on a driver's operation) in the future such that a surrounding status of the subject vehicle M can be responded. The target trajectory, for example, includes a speed element. For example, the target trajectory is represented as a sequence of places (trajectory points) at which the subject vehicle M will arrive. A trajectory point is a place at which the subject vehicle M will arrive at respective predetermined traveling distances (for example, about every several [m]) as distances along the road, and separately from that, a target speed and a target acceleration for each of predetermined sampling times (for example, a fraction of a [sec]) are generated as a part of the target trajectory. A trajectory point may be a position at which the subject vehicle M will arrive at a sampling time for every predetermined sampling time. In such a case, information of a target speed and a target acceleration is represented at the interval of trajectory points.

More specifically, the action plan generator 140 of the automated driving control device 100 according to this embodiment has a function for generating a target trajectory (hereinafter referred to as a “wet-time action planning function”) such that movement control of a vehicle in the horizontal direction is inhibited from being unstable in accordance with degradation of a recognition accuracy of road partition lines when the vehicle is traveling on the road surface at the time of raining or in a wet state. Details of the wet-time action planning function will be described below.

In generating a target trajectory, the action plan generator 140 may set events of automated driving. As events of automated driving, there are a constant-speed traveling event, a low-speed following traveling event, a lane change event, a branching event, a merging event, a take-over event, and the like. The action plan generator 140 generates a target trajectory according to the operated events.

The mode determiner 150 determines the drive mode of the subject vehicle M to be one of a plurality of drive modes in which tasks imposed on a driver are different. For example, the mode determiner 150 includes a driver state determiner 152 and a mode change processor 154. Such individual functions will be described below.

FIG. 3 is a diagram illustrating an example of a correspondence relation among a drive mode, a control state of a subject vehicle M, and a task. As drive modes of the subject vehicle M, for example, there are five modes including Mode A to Mode E. A control state, that is, the degree of automation of driving control of the subject vehicle M is the highest in Mode A and is lowered in order of Mode B, Mode C, and Mode D after Mode A, and Mode E has a lowest control state. To the contrary, the degree of tasks imposed on a driver is the lowest in Mode A and becomes higher in order of Mode B, Mode C, and Mode D after Mode A, and the degree of Mode E is the highest. In Modes D and E, the control state is a state other than automated driving, and thus the automated driving control device 100 ends control relating to automated driving and has a role until a transition to driving assistance or manual driving is performed. Hereinafter, details of each drive mode will be described as an example.

In Mode A, an automated driving state is formed, and both front-side monitoring and grasping of the steering wheel 82 (steering wheel grasping in the drawing) are not imposed on a driver. However, even in Mode A, the driver needs to have a posture of the body that can be quickly transitioned to manual driving in response to a request from a system having the automated driving control device 100 as the center. The automated driving described here means that all the steering and acceleration/deceleration are controlled without being dependent on a driver's operation. Here, a front side means a space in the traveling direction of the subject vehicle M that is visually recognized through a front windshield. Mode A, for example, is a drive mode that can be executed in a case in which conditions such as the subject vehicle M traveling at a speed equal to or lower than a predetermined speed (for example, about 50 [km/h]) on a motorway such as an expressway and a preceding vehicle that is a following target being present are satisfied and may be referred to as a traffic jam pilot (TJP). In a case in which such conditions are not satisfied, the mode determiner 150 changes the drive mode of the subject vehicle M to Mode B.

In Mode B, a driving assisting state is formed, a task of monitoring the front side of the subject vehicle M (hereinafter referred to as front-side monitoring) is imposed on the driver, and a task of grasping the steering wheel 82 is not imposed. In Mode C, a driving assisting state is formed, and the task of front-side monitoring and the task of grasping the steering wheel 82 are imposed on the driver. Mode D is a drive mode in which a driver's driving operation of a certain degree is necessary for at least one of steering and acceleration/deceleration of the subject vehicle M. For example, in Mode D, driving assistance such as adaptive cruise control (ACC) and a lane keeping assist system (LKAS) is performed. In Mode E, a manual driving state in which driver's driving operations are necessary for both steering and acceleration/deceleration is formed. In both Mode D and Mode E, naturally, the task of monitoring the front side of the subject vehicle M is imposed on the driver.

The automated driving control device 100 (and a driving assisting device (not illustrated)) performs an automated lane change according to a drive mode. As automated lane changes, there is an automated lane change (1) according to a system request and an automated lane change (2) according to a driver's request. As the automated lane change (1), there are an automated lane change for overtaking that is performed in a case in which the speed of a preceding vehicle is lower than the speed of the subject vehicle by a reference or more and an automated lane change for traveling toward a destination (an automated lane change according to a change of a recommended lane). In the automated lane change (2), in a case in which conditions relating to a speed, a positional relation with a surrounding vehicle, and the like are satisfied, when a driver's direction indictor is operated by a driver, the lane of the subject vehicle M is changed toward an operated direction.

The automated driving control device 100 performs none of both the automated lane changes (1) and (2) in Mode A. The automated driving control device 100 performs both the automated lane changes (1) and (2) in Modes B and C. The driving assisting device (not illustrated) performs the automated lane change (2) without performing the automated lane change (1) in Mode D. None of both automated lane changes (1) and (2) is performed in Mode E.

In a case in which a task relating to the determined drive mode (hereinafter referred to as a current drive mode) is not performed by the driver, the mode determiner 150 changes the drive mode of the subject vehicle M to a drive mode of which a task is of a higher degree.

For example, in a case in which a driver has a posture of the body in which a transition to manual driving cannot be performed in accordance with a request from the system (for example, in a case in which the driver continues to look away outside an allowed area or in a case in which a sign making it difficult to perform driving is detected) in Mode A, the mode determiner 150 performs control of urging the driver to make a transition to manual driving using the HMI 30 and gradually stopping the subject vehicle M to be pulled over and stopping the automated driving in a case in which the driver does not respond. After the automated driving is stopped, the subject vehicle comes into the state of Mode D or E, and the subject vehicle M can be started by a driver's manual driving. Hereinafter, this similarly applies to “stopping of automated driving”. In a case in which a driver is not monitoring the front side in Mode B, the mode determiner 150 performs control of urging the driver to monitor the front side using the HMI 30 and gradually stopping the subject vehicle M to be pulled over and stopping the automated driving in a case in which the driver does not respond. In a case in which the driver is not monitoring the front side or in a case in which the driver is not grasping the steering wheel 82 in Mode C, the mode determiner 150 performs control of urging the driver to monitor the front side using the HMI 30 and/or grasp the steering wheel 82 and gradually stopping the subject vehicle M to be pulled over and stopping the automated driving in a case in which the driver does not respond.

In order to change the mode, the driver state determiner 152 monitors the state of the driver and determines whether or not the state of the driver is a state according to the task. For example, the driver state determiner 152 performs a posture estimating process by analyzing an image captured by the driver monitor camera 70 and determines whether or not the driver has a posture of the body in which a transition to manual driving cannot be performed in response to a request from the system. The driver state determiner 152 performs a visual line estimating process by analyzing the image captured by the driver monitor camera 70 and determines whether or not the driver is monitoring the front side.

The mode change processor 154 performs various processes for changing the mode. For example, the mode change processor 154 instructs the action plan generator 140 to generate a target trajectory for stopping on the road shoulder, instructs the driving assisting device (not illustrated) to operate, or controls the HMI 30 for urging the driver to perform an action.

The second controller 160 performs control of the traveling driving force output device 200, the brake device 210, and the steering device 220 such that the subject vehicle M passes through the target trajectory generated by the action plan generator 140 at a scheduled time.

Referring back to FIG. 2, the second controller 160, for example, includes an acquirer 162, a speed controller 164, and a steering controller 166. The acquirer 162 acquires information of a target trajectory (trajectory points) generated by the action plan generator 140 and stores the acquired target trajectory in a memory (not illustrated). The speed controller 164 controls the traveling driving force output device 200 or the brake device 210 based on speed elements accompanying the target trajectory stored in the memory. The steering controller 166 controls the steering device 220 in accordance with a bending state of the target trajectory stored in the memory. The processes of the speed controller 164 and the steering controller 166, for example, are realized by a combination of feed-forward control and feedback control. As one example, the steering controller 166 executes feed-forward control according to a curvature of a road disposed in front of the subject vehicle M and feedback control based on a deviation from a target trajectory in combination.

The traveling driving force output device 200 outputs a traveling driving force (torque) for enabling the vehicle to travel to driving wheels. The traveling driving force output device 200, for example, includes a combination of an internal combustion engine, an electric motor, and a transmission, and an electronic control unit (ECU) controlling these. The ECU controls the components described above in accordance with information input from the second controller 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second controller 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second controller 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second controller 160 or information input from the driving operator 80.

[Action Planning Function at Time of being Wet]

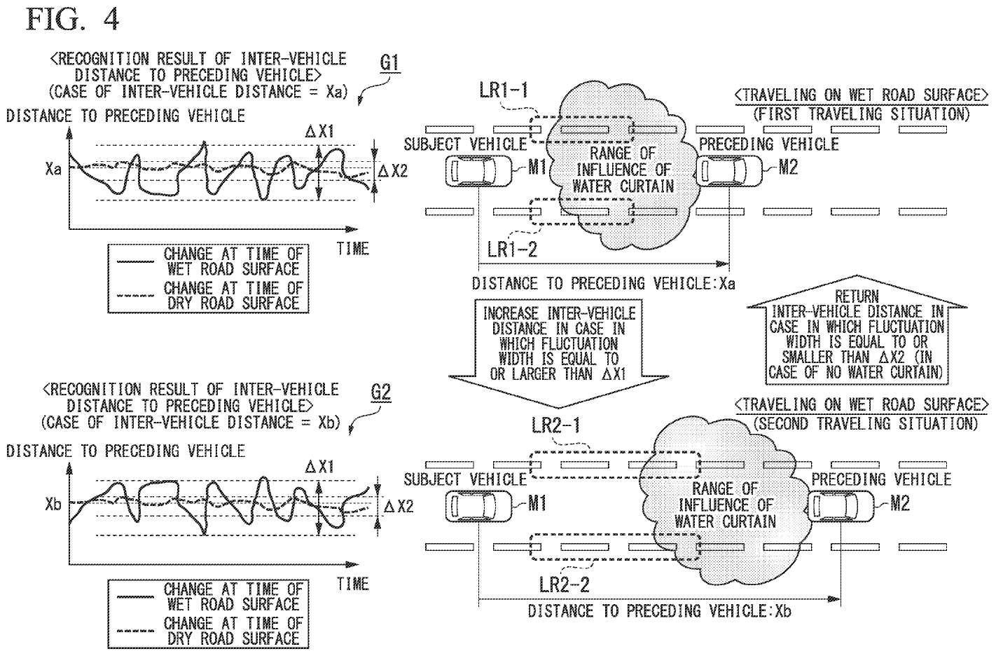

FIG. 4 is a diagram illustrating an overview of the wet-time action planning function that is included in the action plan generator 140. Graphs G1 and G2 illustrated in FIG. 4 are graphs illustrating examples of recognition results of a distance between a subject vehicle M1 and a preceding vehicle M2 traveling in front of the subject vehicle M1 in corresponding traveling situations. Both the graphs G1 and G2 represent recognition results of an inter-vehicle distance to a preceding vehicle in a situation in which a subject vehicle is traveling on a road surface that is in a wet state at the time of raining or the like. The graph G1 represents a recognition result in a situation in which an inter-vehicle distance between the subject vehicle M1 and the preceding vehicle M2 is relatively short (hereinafter referred to as a “first traveling situation”), and the graph G2 represents a recognition result in a situation in which an inter-vehicle distance between the subject vehicle M1 and the preceding vehicle M2 is relatively long (hereinafter referred to as a “second traveling situation”). FIG. 4 illustrates a situation in which an inter-vehicle distance in the first traveling situation is Xa, and an inter-vehicle distance in the second traveling situation is Xb (>Xa). An inter-vehicle distance between the subject vehicle M1 and the preceding vehicle M2, for example, is recognized by the recognizer 130 and is notified to the action plan generator 140.

The first traveling situation is a situation in which most of road partition lines in front of the subject vehicle M1 are covered with water raised by the preceding vehicle M2 (hereinafter also referred to as a “water curtain”) due to a short inter-vehicle distance between the subject vehicle M1 and the preceding vehicle M2, and it becomes difficult for the subject vehicle M1 to recognize road partition lines. The first traveling situation is a situation in which recognition of the preceding vehicle M2 using the subject vehicle M1 becomes difficult as well in accordance with the influence of the water curtain. Degradation of a recognition accuracy for the preceding vehicle M2 is confirmed in accordance with large fluctuation of the recognition result of the inter-vehicle distance between the subject vehicle M1 and the preceding vehicle M2 (for example, see the graph G1).

The second traveling situation is similar to the first traveling situation in that it is a situation in which a recognition accuracy of the subject vehicle M1 for the preceding vehicle M2 is degraded in accordance with the influence of a water curtain raised by the preceding vehicle M2. Similar to the case of the first traveling situation, degradation of a recognition accuracy for the preceding vehicle M2 is confirmed in accordance with large fluctuation of the recognition result of the inter-vehicle distance between the subject vehicle M1 and the preceding vehicle M2 (for example, see the graph G2). On the other hand, in the second traveling situation, a range not influenced by the effect of the water curtain (in other words, not covered with the water curtain) raised by the preceding vehicle M2 in road partition lines in front of the subject vehicle M1 due to the long inter-vehicle distance between the subject vehicle M1 and the preceding vehicle M2 becomes large, and a recognition accuracy of the road partition lines is enhanced to some degree, which is different from the first traveling situation.

The wet-time action planning function that is included in the action plan generator 140 according to this embodiment generates an action plan for increasing the inter-vehicle distance between the subject vehicle M1 and the preceding vehicle M2 in a case in which the recognition accuracy for the preceding vehicle M2 is equal to or smaller than a threshold in the first traveling situation and generates an action plan for decreasing the inter-vehicle distance between the subject vehicle M1 and the preceding vehicle M2 in a case in which the recognition accuracy for the preceding vehicle M2 is equal to or larger than a threshold in the second traveling situation.

More specifically, by using a magnitude of fluctuation of a recognition result (hereinafter, referred to as “a fluctuation width”) as a recognition accuracy for the preceding vehicle M2, the action plan generator 140 generates an action plan for increasing the inter-vehicle distance between the subject vehicle M1 and the preceding vehicle M2 in a case in which the fluctuation width in the first traveling situation is equal to or larger than a threshold ΔX1. On the other hand, the action plan generator 140 generates an action plan for decreasing the inter-vehicle distance between the subject vehicle M1 and the preceding vehicle M2 in a case in which the fluctuation width in the second traveling situation is equal to or smaller than a threshold ΔX2.

By measuring a fluctuation width at the time of traveling on a road surface that is in a dry state and a fluctuation width at the time of traveling on a road surface that is in a wet state in advance, the first threshold ΔX1 and the second threshold ΔX2 may be determined based on results of the measurement and a range (an allowed range) of the recognition accuracy for the road partition lines that is allowed.

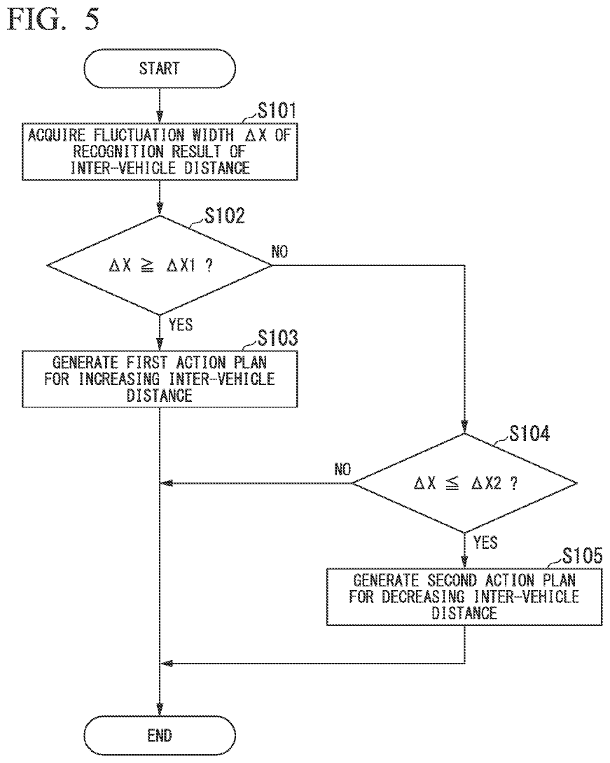

FIG. 5 is a flowchart illustrating an example of the flow of a process performed in relation with the wet-time action planning function (hereinafter referred to as an “action plan generating process at the time of being wet”) by the action plan generator 140. Here, for the simplification of description, although the flow of the process performed in accordance with control of one period will be described, actually, by repeatedly performing the flow illustrated in FIG. 5, adjustment of the inter-vehicle distance is continuously performed. First, the action plan generator 140 acquires a recognition result of an inter-vehicle distance between the subject vehicle and the preceding vehicle from the recognizer 130 and acquires a value of the fluctuation width ΔX of the recognition result based on the acquired recognition result (Step S101). For example, the action plan generator 140 may acquire a plurality of recognition results acquired between the present and a predetermined time point in the past from the recognizer 130 and acquire a difference between a maximum value and a minimum value among the plurality of acquired recognition results as a magnitude of the fluctuation width ΔX.

Subsequently, the action plan generator 140 determines whether or not the magnitude of the acquired fluctuation width ΔX is equal to or larger than a first threshold ΔX1 (Step S102). Here, in a case in which it is determined that the magnitude of the fluctuation width ΔX is equal to or larger than the first threshold ΔX1, the action plan generator 140 generates an action plan for increasing the inter-vehicle distance between the subject vehicle and the preceding vehicle (Step S103). The action plan generator 140 notifies the second controller 160 of the generated action plan and ends the wet-time action plan generating process.

On the other hand, in a case in which it is determined that the magnitude of the fluctuation width ΔX is smaller than the first threshold ΔX1 in Step S102, the action plan generator 140 determines whether or not the magnitude of the fluctuation width ΔX acquired in Step S101 is equal to or smaller than a second threshold ΔX2 (Step S104). Here, in a case in which it is determined that the magnitude of the fluctuation width ΔX is equal to or smaller than the second threshold ΔX2, the action plan generator 140 generates an action plan for decreasing the inter-vehicle distance between the subject vehicle and the preceding vehicle (Step S105). The action plan generator 140 notifies the second controller 160 of the generated action plan and ends the wet-time action plan generating process. On the other hand, in a case in which it is determined that the magnitude of the fluctuation width ΔX is larger than the second threshold ΔX2 in Step S104, the action plan generator 140 skips Step S105 and ends the wet-time action plan generating process.

In a case in which an action plan for increasing the inter-vehicle distance is generated in Step S103, a degree of the increase in the inter-vehicle distance may be determined in accordance with a current inter-vehicle distance and a traveling speed. Similarly, also in a case in which an action plan for decreasing the inter-vehicle distance is generated in Step S105, a degree of the decrease in the inter-vehicle distance may be determined in accordance with a current inter-vehicle distance and a traveling speed. For example, in a case in which the distance from the subject vehicle to the preceding vehicle remains the same, it is assumed that there will be a wider range in which a water curtain has an influence in a situation in which the traveling speed is higher. For this reason, in a case in which the inter-vehicle distance is increased, the action plan generator 140 may generate an action plan for increasing the inter-vehicle distance as the traveling speed becomes higher. On the other hand, in a case in which the inter-vehicle distance is decreased, the action plan generator 140 may generate an action plan for decreasing the inter-vehicle distance as the traveling speed becomes lower.

Even in a case in which the inter-vehicle distance is made to become longer in accordance with the action plan generated in Step S102, depending on situations such as a brightness in the vicinity of the subject vehicle, rainfall, and the like, occurrence of a situation in which a recognition accuracy of road partition lines is still low may be considered. In consideration of such situations, the recognizer 130 according to this embodiment has a function for recognizing an object marker (hereinafter referred to as a “substitute marker”) instead of road partition lines (hereinafter referred to as a “substitute marker recognizing function”) such that the action plan generator 140 can continue horizontal movement control of the subject vehicle even in such a case. The recognizer 130 notifies the action plan generator 140 of a result of recognition of a substitute marker, and the action plan generator 140 performs horizontal movement control of the subject vehicle using the substitute marker recognized by the recognizer 130.

### [Substitute Marker Recognizing Function]

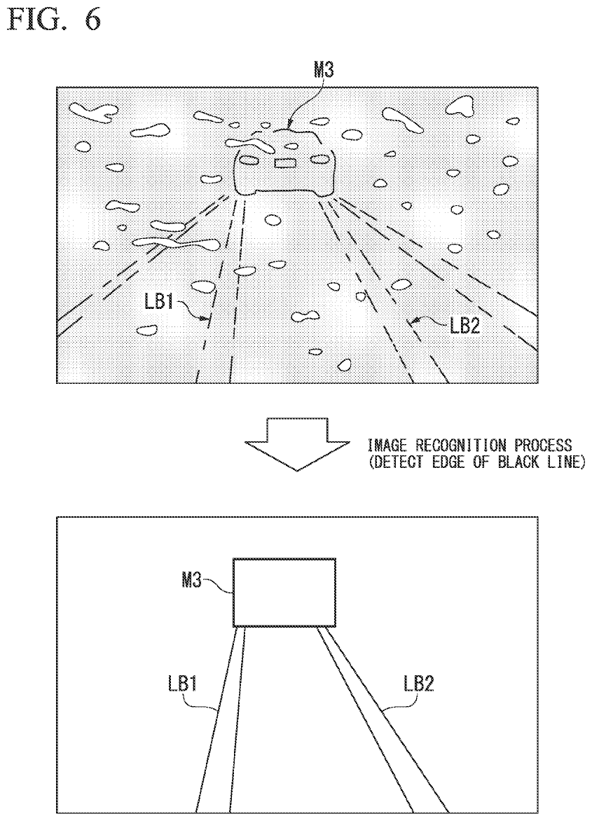

FIG. 6 is a diagram illustrating an overview of the substitute marker recognizing function of the recognizer 130. In this embodiment, the substitute marker recognizing function of the recognizer 130 is a function for recognizing a traveling trajectory of a preceding vehicle on a road during traveling on the road that is in a wet state as a substitute marker. For example, an image IM1 illustrated in FIG. 6 is an image acquired by capturing a preceding vehicle M3 from the subject vehicle during traveling at the time of raining. As can be understood from this image IM1, the road surface during rain is seen to be white in accordance with reflection of light according to rainwater, and a part through which tires of the preceding vehicle M3 have passed is seen to be blackish due to pressing of rainwater. In this way, in an image of a road that is in a sufficiently wet state, a traveling trajectory of a vehicle that has traveled on this road appears as black lines (in the example illustrated in FIG. 6, LB1 and LB2).

Thus, the recognizer 130 performs an image recognizing process for detecting edges of black lines growing from the preceding vehicle on an image on which a road surface between the subject vehicle and the preceding vehicle is captured, thereby recognizing a traveling trajectory of the preceding vehicle. For example, the recognizer 130 performs image processing with a white color and a black color of a filter, which is used at the time of recognizing road partition lines, reversed, thereby being able to detect black lines. For example, the recognizer 130 can acquire a recognition result as an image IM2 as a result of performance of an image recognition process on the image IM1 illustrated in FIG. 6. The recognizer 130 notifies the action plan generator 140 of the recognition result.

As can be understood from the example illustrated in FIG. 6, the recognized traveling trajectory of the preceding vehicle is approximately parallel to road partition lines, and thus, the action plan generator 140 can continuously perform movement control of the subject vehicle in a horizontal direction by estimating road partition lines using the recognized traveling trajectory as a reference and using the estimated road partition lines.

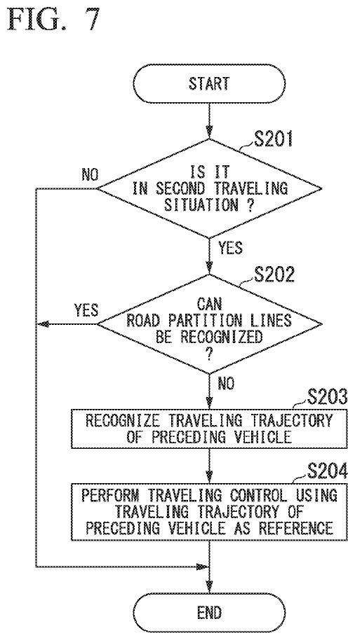

FIG. 7 is a flowchart illustrating an example of the flow of a process of the action plan generator 140 generating an action plan based on a recognition result of a substitute marker. Here, for the simplification of description, although the flow of the process performed in accordance with control of one period will be described, by repeatedly performing the flow illustrated in FIG. 7, a substitute marker is recognized at an appropriate necessary timing. First, the action plan generator 140 determines whether or not the traveling situation of the subject vehicle is the second traveling situation (Step S201). Here, in a case in which it is determined that the traveling situation of the subject vehicle is the second traveling situation, the action plan generator 140 determines whether or not road partition lines are recognized by the recognizer 130 (Step S202). Here, in a case in which it is determined that road partition lines are recognized or in a case in which it is determined that the traveling situation of the subject vehicle is not the second traveling situation in Step S201, the action plan generator 140 ends a series of processing flows.

On the other hand, in a case in which it is determined that road partition lines are not recognized in Step S202, the action plan generator 140 instructs the recognizer 130 to recognize a substitute marker, and the recognizer 130 performs an image recognition process in accordance with this instruction, thereby recognizing the traveling trajectory of the preceding vehicle as a substitute marker (Step S203). The recognizer 130 notifies the action plan generator 140 of the result of recognition of the substitute marker, and the action plan generator 140 generates an action plan using the recognized substitute marker, thereby performing control of movement of the subject vehicle in the horizontal direction (Step S204).

The processing flow illustrated in FIG. 7 may be embedded into part of the wet-time action plan generating process described with reference to FIG. 5, and the substitute marker recognized in the processing flow illustrated in FIG. 7 may be used in a process other than the wet-time action plan generating process.

By including the recognizer 130 recognizing an inter-vehicle distance between the subject vehicle and the preceding vehicle and the action plan generator 140 generating an action plan for changing the inter-vehicle distance between the subject vehicle and the preceding vehicle based on a result of the recognition of the inter-vehicle distance, the automated driving control device 100 according to the embodiment configured in this way can more stably control movement of the subject vehicle in the horizontal direction in a situation in which the subject vehicle is traveling on a road that is in a wet state.

As above, while the forms for performing the present invention have been described with reference to the embodiment, the present invention is not limited to such an embodiment at all, and various modifications and substitutions can be made within a range not departing from the concept of the present invention.

What is claimed is:

1. A vehicle control device comprising:
a storage device configured to store a program; and
a hardware processor,
wherein, by executing the program stored in the storage device, the hardware processor performs:
a recognition process of recognizing a situation of the vicinity of a subject vehicle; and
an action plan generating process of generating an action plan of the subject vehicle based on a result of the recognition of the vicinity of the subject vehicle,
wherein an inter-vehicle distance between the subject vehicle and another vehicle traveling in front of the subject vehicle is recognized in the recognition process, and
wherein the action plan for changing the inter-vehicle distance between the subject vehicle and the other vehicle is generated based on the result of the recognition of the inter-vehicle distance in the action plan generating process.

2. The vehicle control device according to claim 1, wherein the hardware processor generates a first action plan for increasing the inter-vehicle distance between the subject vehicle and the other vehicle in a case in which an accuracy of recognition of road partition lines using a recognizer is degraded beyond a specific allowed range.

3. The vehicle control device according to claim 2, wherein the case in which the accuracy of recognition of the road partition lines is degraded beyond the specific allowed range is a case in which a magnitude of fluctuation of the result of the recognition of the inter-vehicle distance is equal to or larger than a first threshold.

4. The vehicle control device according to claim 3, wherein the hardware processor generates a second action plan for decreasing the inter-vehicle distance between the subject vehicle and the other vehicle in a case in which the magnitude of fluctuation of the result of the recognition of the inter-vehicle distance is equal to or smaller than a second threshold that is smaller than the first threshold.

5. The vehicle control device according to claim 2, wherein the hardware processor determines the inter-vehicle distance after change in accordance with a current traveling speed of the subject vehicle.

6. The vehicle control device according to claim 2, wherein, in a case in which the accuracy of recognition of the road partition lines is not enhanced to be within the allowed range even when traveling control of the subject vehicle is performed using the first action plan, the hardware processor recognizes a traveling trajectory of the other vehicle as a substitute marker for the road partition lines from an image of a road on which the other vehicle has traveled.

7. A vehicle control method using a computer, the vehicle control method comprising:
a recognition process of recognizing a situation of the vicinity of a subject vehicle; and
an action plan generating process of generating an action plan of the subject vehicle based on a result of the recognition of the vicinity of the subject vehicle in the recognition process,
wherein an inter-vehicle distance between the subject vehicle and another vehicle traveling in front of the subject vehicle is recognized in the recognition process, and
wherein the action plan for changing the inter-vehicle distance between the subject vehicle and the other vehicle is generated based on the result of the recognition of the inter-vehicle distance in the action plan generating process.

8. A computer-readable non-transitory storage medium storing a program thereon, the program causing a computer to perform:
a recognition process of recognizing a situation of the vicinity of a subject vehicle; and
an action plan generating process of generating an action plan of the subject vehicle based on a result of the recognition of the vicinity of the subject vehicle in the recognition process,
wherein an inter-vehicle distance between the subject vehicle and another vehicle traveling in front of the subject vehicle is recognized in the recognition process, and
wherein the action plan for changing the inter-vehicle distance between the subject vehicle and the other vehicle is generated based on the result of the recognition of the inter-vehicle distance in the action plan generating process.
